(19) United States
(12) Patent Application Publication
(10) Pub. No.: US 2009/0240681 A1
(43) Pub. Date: Sep. 24, 2009

(54) MEDICAL RECORDS NETWORK

(76) Inventors: Nadeem Saddiqi, Knoxville, TN (US); Christopher J. Kennedy, Maryville, TN (US)

Correspondence Address: LUEDEKA, NEELY & GRAHAM, P.C., P O BOX 1871, KNOXVILLE, TN, 37901, US

(21) Appl. No.: 12/052,222

(22) Filed: Mar. 20, 2008

(51) Int. Cl. G06F 17/30

(52) U.S. Cl. 707/5; 707/E17.014

(57) ABSTRACT

A medical records network is configured for communicating a plurality of electronic medical records over authenticated peer-to-peer connections among a plurality of client computer systems. The medical records network includes a first client computer system running a first agent application for generating an authentication request and a record request query to request access to one or more medical records stored on one or more other client computer systems. A proxy computer system receives and processes the authentication request and determines whether the first client computer system should be granted access to the medical records network. If the first client computer system is authenticated, the proxy computer system processes the record request query and forwards a proxy query to those client computer systems in a specific geographic region. The client computer systems receiving the record request query respond indicating whether they have access to the requested record(s). If so, the proxy computer system facilitates an encrypted peer-to-peer communication channel between the first client computer system and the client computer system(s) responding affirmatively in order to communicate the record(s) to the first client computer system.

### FIELD

This disclosure relates to the field of medical records management. More particularly, the disclosure relates to a medical records network for communicating electronic medical records over authenticated peer-to-peer connections from a records database.

### BACKGROUND AND SUMMARY

Referring to FIG. 1, a prior art example is shown. Electronic medical records (EMRs) are stored in numerous different formats by EMR computer systems 2 at health care providers such as doctors' offices and hospitals. Most of the EMR computers 2 have access to communication networks 4 such as the Internet, but they cannot effectively and securely communicate with one another because of the many different types of EMR database applications 6 running on the various EMR computer systems 2 and because of the lack of authorizations for record transfers. The various EMR database applications 6 running on the EMR computer systems 2 manage local EMR databases 8 where the EMRs are stored. Previous EMR computer systems 2 had no means by which to search or transfer the EMRs stored on the local EMR databases 8 of other EMR computer systems 2. Furthermore, previous EMR computer systems 2 were incapable of performing peer-to-peer records searching and transferring.

Thus, there is a need for a medical records network for providing communication between numerous EMR computer systems 2, providing access to the EMRs stored in local EMR databases 8, and allowing remote EMR computer systems 2 to perform peer-to-peer searching and transferring of EMRs.

The above and other needs are met by a medical records network for providing communication between a plurality of client computer systems, one or more of which store medical records.

The medical records network has a first client computer system including a first client processor for executing instructions to provide access to medical records and a first agent application running on the first client processor. The first agent application generates an authentication request and a first record request query to request access to one or more medical records stored on one or more other client computer systems. The first record request query includes query information for identifying the one or more medical records to be accessed. The medical records network also has a communication network connected to the first client computer system for communicating the authentication request and the first record request query to one or more other computer systems connected to the communication network.

A proxy computer system is connected to the communication network and is operable to receive the authentication request and the first record request query. The proxy computer system has a proxy database containing at least authentication data and a proxy processor for executing instructions to access the authentication data contained in the proxy database and determine whether one or more of the client computer systems are authorized to communicate over the medical records network. The proxy processor executes instructions enabling communication between client computer systems authorized to communicate medical records over the medical records network. A proxy application runs on the proxy processor and determines, based at least in part on the accessed authentication data and the authentication request, whether the first client computer system is authorized to communicate over the medical records network. In addition, the proxy application generates a first proxy query based on the query information in the first record request query. The communication network communicates the first proxy query to one or more other computer systems connected to the communication network, and a second client computer system connected to the communication network receives the first proxy query.

The second client computer system has a second client processor for executing instructions to provide access to medical records, a second client database containing one or more medical records, and a second agent application running on the second client processor for determining, based on the first proxy query, whether the one or more medical records requested by the first client computer system are contained in the second client database. The second agent application also generates a positive query response when the one or more medical records requested by the first client computer system are contained in the second client database. The communication network communicates the positive query response to the proxy computer system, and the proxy application receives the positive query response and establishes a secure communication channel via the communication network between the first client computer system and the second client computer system based on the positive query response. The second client computer system communicates the requested one or more medical records to the first client computer system via the secure communication channel.

In some embodiments, the first record request query includes the authentication request, and in others, the first record request query includes identification information for identifying the first client computer system. In yet other embodiments, the authentication request includes a first password and the authentication data contains at least a second password. The proxy processor determines whether the first password corresponds to the second password and therefore whether the first client computer system is authorized to communicate over the medical records network based at least in part on whether the first password corresponds to the second password.

In other embodiments, the authentication data includes access information representing one or more client computer systems authorized to access the medical records network and identification information for identifying the first client computer system. The proxy processor determines whether the identification information corresponds to at least one of the client computer systems represented by the access information and therefore whether the first client computer system is authorized to communicate over the medical records network.

The above and other needs are also met by a method for providing communication over a medical records network including a plurality of client computer systems, where one or more of the client computer systems is operable for storing medical records. The method begins by generating an authentication request and a first record request query at a first client computer system, the first record request query for requesting access to one or more medical records stored on one or more client computer systems other than the first client computer system, the first record request query including query information for identifying the one or more medical records to be accessed. The next step is communicating the authentication request and the first record request query to one or more computer systems other than the first client computer system connected to a communication network and then receiving the authentication request and the first record request query at a proxy computer system connected to the communication network. The next method step is accessing authentication data contained in a proxy database of the proxy computer system and then determining that the first client computer system is authorized to communicate over the medical records network based at least in part on the accessed authentication data and the authentication request. Then, the proxy computer system generates a first proxy query based on the query information in the first record request query and communicates the first proxy query to one or more other computer systems connected to the communication network.

Next, a second client computer system connected to the communication network receives the first proxy query. The next step is accessing a second client database that is associated with the second client computer system and then determining, based on the first proxy query, whether the one or more medical records requested by the first client computer system are contained in the second client database. Then, a positive query response is generated when the one or more medical records requested by the first client computer system are contained in the second client database, and the positive query response is communicated to the proxy computer system. The final steps are receiving the positive query response at the proxy computer system and establishing a communication channel via the communication network between the first client computer system and the second client computer system based on the positive query response, whereby the second client computer system may communicate the requested one or more medical records to the first client computer system via the communication channel.

In other embodiments of the method, the first record request query includes the authentication request and identification information for identifying the first client computer system. In yet other embodiments, the authentication request includes a first password and the authentication data contains at least a second password. Next, the method determines that the first password corresponds to the second password and therefore that the first client computer system is authorized to communicate over the medical records network.

In other embodiments, the authentication data includes access information representing one or more client computer systems authorized to access the medical records network, and the authentication request includes identification information for identifying the first client computer system. Next, the proxy processor determines whether the identification information corresponds to at least one of the client computer systems represented by the access information and therefore whether the first client computer system is authorized to communicate over the medical records network.

In yet other embodiments, the method includes generating a negative query response when the one or more medical records requested by the first client computer system are not found in the second client database, communicating the negative query response to the proxy computer system, receiving the negative query response at the proxy computer system, and generating a second record request query which is at least in part distinct from the first record request query.

In other embodiments, the authentication request includes client information and the method also includes storing the client information at the proxy computer system. The client information includes region information indicating a geographic location of the first client computer system and network identification information indicating a unique network address of the first client computer system.

In another embodiment, the method includes storing client region information in the proxy database, where the client region information indicates geographic locations of one or more client computer systems authorized to access medical records via the medical records network. The first record request query includes query region information indicating a geographic region within which to communicate the first proxy query, and the method includes determining which, if any, of the client region information stored in the proxy database corresponds with the query region information. In this embodiment the first proxy query is communicated to the one or more client computer systems in geographic locations corresponding with the query region information in the first record request query.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a diagram of a prior art embodiment.

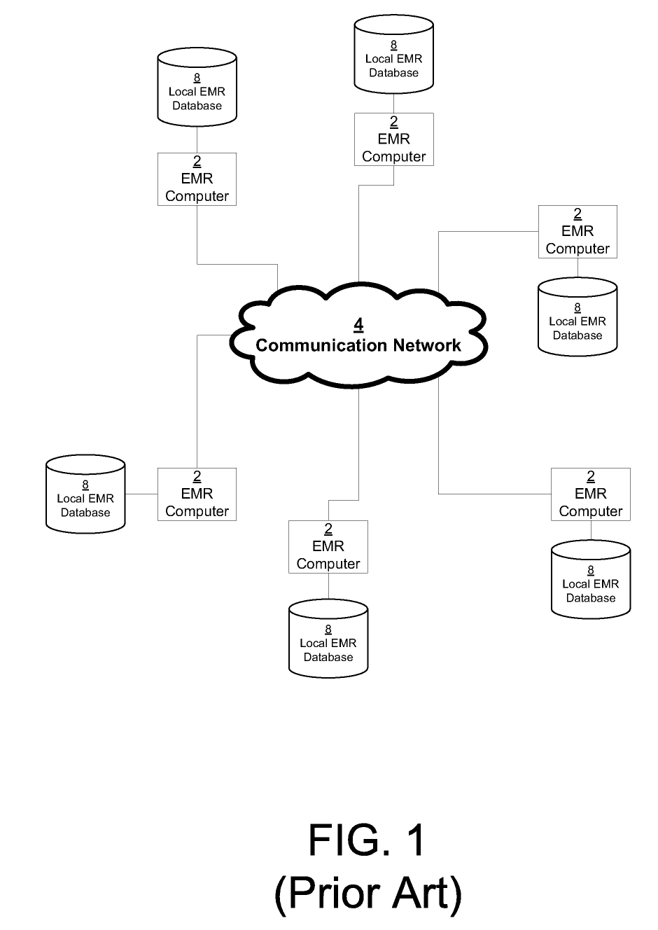

FIG. 2 is a diagram of the medical records network of the present invention.

FIG. 3 is a flowchart representing the steps of the client computer system authentication process.

FIG. 4 is a flowchart representing the steps of the record request process.

FIG. 5 is a flowchart representing the steps of the EMR communication process.

### DETAILED DESCRIPTION

Various embodiments of the present invention provide a medical records network 10 configured for providing access to client computer systems for EMR searching and secure, peer-to-peer transferring of EMRs. Each individual client computer system is authenticated to a proxy computer system, which facilitates EMR searches and secure, peer-to-peer transfer of EMRs between client computer systems without the necessity of a centralized EMR database.

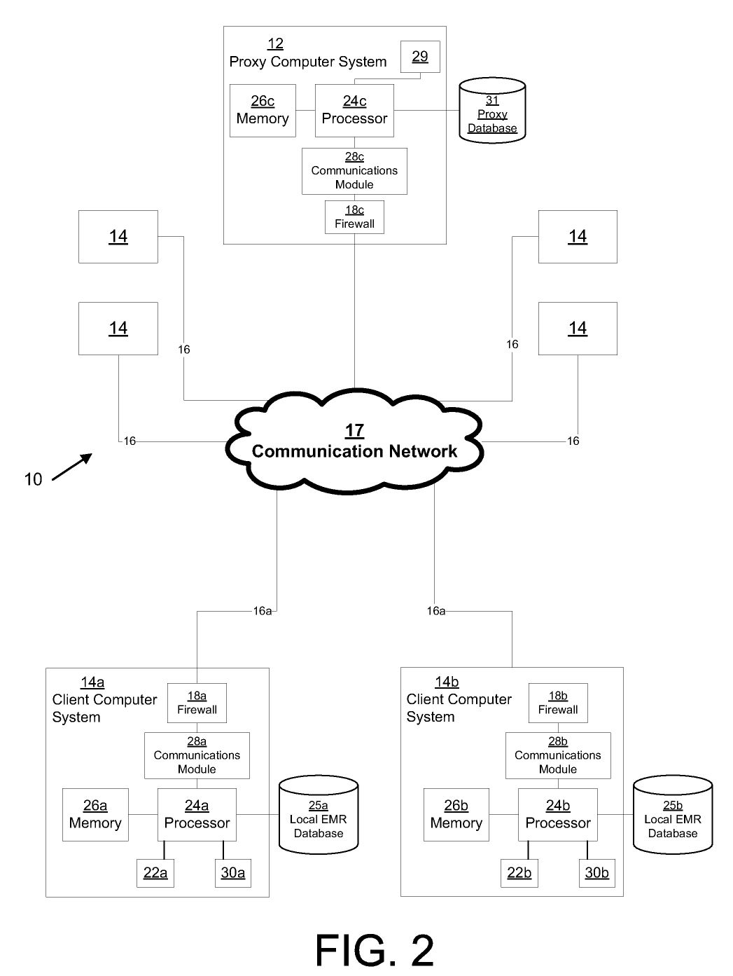

With initial reference to FIG. 2, the medical records network 10 includes a proxy computer system 12 for, among other functions, performing peer-to-peer authentication for one or more client computer systems 14. Typically, a client computer system 14a is connected to the proxy computer system 12 over a communication pathway 16a and through a firewall 18a. Similarly, a second client computer system 14b is connected to the proxy computer system 12 over a communication pathway 16b and through a firewall 18b. In most applications, many client computer systems 14 are connected to the proxy computer system 12 over many communication pathways 16. In most embodiments, the communication pathways 16 are components of or are connected to a global communication network 17, such as the Internet. In some applications, the communication pathways 16 are portions of local area networks and/or wide area networks other than the Internet.

A client computer system 14, for example 14a, in most embodiments includes a processor 24a, a memory 26a, a communications module 28a, an agent application 22a running on the processor 24a, an EMR database application 30a running on the processor 24a, and a local EMR database 25a. The communications module 28a is controlled by the processor 24a for communicating over the communications network 17 and, once authenticated, over the medical records network 10 as discussed below. The memory 26a stores the agent application 22a, and in some applications, the memory 26a also stores the EMR server application 30a, which is a software application for managing and, when prompted by the agent application 22a, communicating one or more EMRs stored in the local EMR database 25a over the medical records network 10. The agent application 22a is a software module that runs on the processor 24a of the client computer system 14a and performs processes such as authenticating the client computer system 14a to the proxy computer system 12, responding to queries from the proxy computer system 12, sending queries to the proxy computer system 12, and performing other functions as discussed below. The local EMR database 25a is accessible to the processor 24a and stores EMRs. The agent application 22a accesses the local EMR database 25a in response to search queries initiated by the proxy computer system 12.

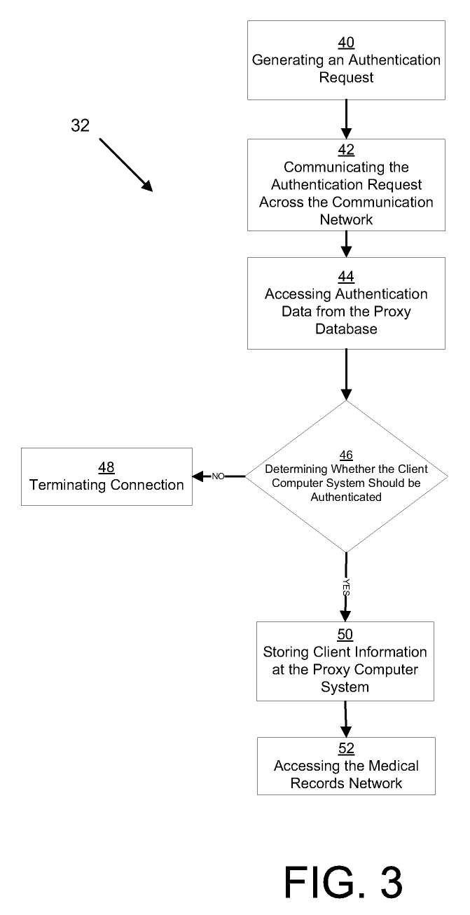

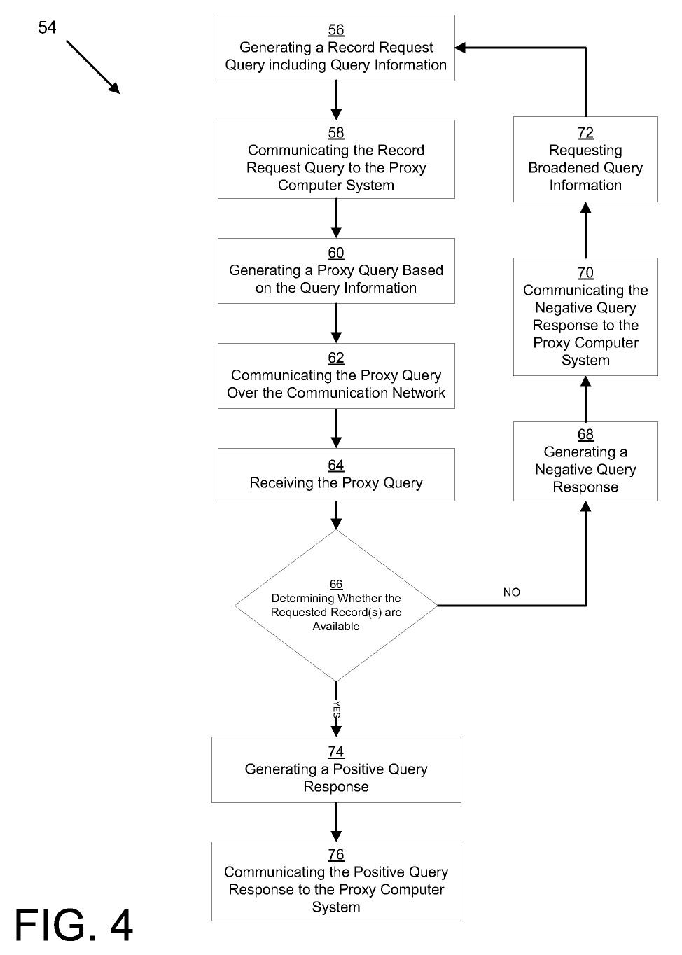

The proxy computer system 12, in most embodiments includes a processor 24c, a memory 26c, a communications module 28c, a firewall 18c, a proxy application 29 running on the processor 24c, and a proxy database 31. The communications module 28c is controlled by the processor 24c for communicating over the communication network 17. The memory 26c stores the proxy application 29 which runs on the processor 24c and performs processes such as receiving authentication requests from client computer systems 14 over the communication network 17 and performing an authentication process as further discussed with reference to FIG. 3 below. The proxy application 29 also receives and executes search queries from client computer systems 14 which have been authenticated to the medical records network 10 as further discussed with reference to FIG. 4 below. In addition, the proxy application 29 facilitates a peer-to-peer communications channel between two client computer systems 14 for the purpose of transferring one or more EMRs. As discussed below, the proxy database 31 is accessible to the processor 24c and stores authentication data used, as discussed below, in the authentication process.

In some embodiments, the client computer system 14a does not run the EMR database application 30a and therefore does not provide other client computer systems access to EMRs stored on the local EMR database 25a. In such a case, the agent application 22a running on the processor 24a of the client computer system 14a may still authenticate with the proxy computer system 12 and send queries to the proxy computer system 12.

Referring now to FIG. 3, a flowchart 32 representing the process steps performed during the authentication process is shown. The authentication process refers to the process whereby the client computer system 14a is authenticated by the proxy computer system 12 and granted access to the medical records network 10. First, an authentication request is generated by the agent application 22a and as represented by block 40. The authentication request includes data used by the proxy processor 24c to determine whether the client computer system 14a communicating the authentication request is authorized to be granted access to the medical records network 10. Typically, the authentication request includes data indicating the identification of the client computer system 14a such as its IP address, a password or the like. Next, the authentication request is communicated by the communications module 28a of the client computer system 14a across the communications network 17 as represented by block 42. In step 42, the integrity of the communication is protected by implementing standards-based, best-of-class encryption algorithms selected from AES, DES, triple-DES, RC4, MACs, SSL, TLS, RSA, DSA or algorithms having similar security capabilities. The authentication request is received by the communications module 28c of the proxy computer system 12 and, if it is encrypted, the proxy processor 24c decodes it.

Next, the proxy processor 24c accesses authentication data contained in the proxy database 31 as represented by block 44. The authentication data includes data used by the proxy processor 24c to determine whether the received authentication request was communicated from a client computer system 14a that should be granted access to the medical records network 10. In the preferred embodiment, the authentication data includes data representing identification information corresponding to those client computer systems 14 that are authorized to be granted access to the medical records network 10. For example, the IP addresses and/or passwords of those client computer systems 14 authorized to be granted access are contained in the authentication data.

Next, the proxy processor 24c determines whether the client computer system should be authenticated as represented by block 46. In step 46, the proxy processor 24c determines whether the authentication data was communicated from a client computer system 14 authorized to be granted access to the medical records network 10 by comparing the authentication request with the authentication data accessed from the proxy database 31. If the client computer system 14 is not authorized to be granted access, the connection between the client computer system 14 and the proxy computer system 12 is terminated as represented by block 48. However, if the client computer system 14 is authorized to be granted access, the proxy processor 24c stores client information at the proxy computer system 12 as represented by block 50 and provides the client computer system 14 with access to the medical records network 10 as represented by block 52.

In the preferred embodiment, the client information includes region information indicating the physical location of the client computer system 14. For example, the region information is a physical or street address where the client computer system 14 is located. The region information is useful when the proxy computer system 12 is determining which authenticated client computer systems 14 should receive a proxy query as discussed below. Additionally, the client information includes network identification information such as the IP address of the client computer system 14 or some other unique identification information. The network identification information is useful when the proxy computer system 12 is responding to a search query as discussed below. The client information is communicated by the client computer system 14a concurrently with the authentication request in the preferred embodiment. In other embodiments, the client information is communicated either before or after the authentication request is communicated.

In another alternate embodiment, the client information is part of the authentication request such that the information contained within the authentication request includes the client information. In such a case, the client information is used in authenticating the client computer system 14 with the proxy computer system 12 and it is stored in the proxy database 31 to be used in search queries as described below. Also, in some alternate embodiments, the client information does not include region information but only network address information, and in other alternate embodiments, the client information does not include network address information but only region information.

In an alternate embodiment of the authentication process, a request password is included in the authentication request communicated by the client computer system across the communication network in step 42. The authentication data in the proxy database includes one or more authorized passwords that are accessed by the proxy processor 24c in step 44. The processor 24c then determines whether the client computer system 14 should be authenticated by comparing the request password included in the authentication data to the authorized password in the authentication data in step 46. The remaining steps are executed as previously described.

Referring now to FIG. 4, a flowchart 54 representing the process steps performed in a record request query is shown. First, a record request query is generated by the agent application 22a running on the processor 24a (step 56). The record request query is for requesting access to one or more EMRs stored on one or more client computer systems 14 other than the client computer system 14a. In the preferred embodiment, the record request query includes query information for identifying the one or more EMRs to be accessed, such as patient name, and identification information for identifying the client computer system 14a. Also, the record request query may include query region information indicating the geographic region in which to search for the one or more EMRs. Next, the communications module 28a communicates the record request query to the proxy computer system 12 over the communication network 17 (step 58). Then the proxy processor 24c generates a proxy query based on the query information of the record request query (step 60). The communications module 28c of the proxy computer system 12 then communicates the proxy query over the communication network 17 (step 62). In the preferred embodiment, the proxy query is communicated only to those client computer systems 14 within the geographic region indicated in the query region information.

Next, the proxy query is received by one or more client computer systems 14b (step 64), and each client computer system processor 24b determines whether the requested EMR(s) are available on the local EMR database (step 66). If the requested EMR is not available, the client computer system 14b generates a negative query response (step 68) and communicates the negative query response to the proxy computer system 12 (step 70). In step 72, the proxy computer system requests broadened query region information from the client computer system 14a that generated the record request query of step 56.

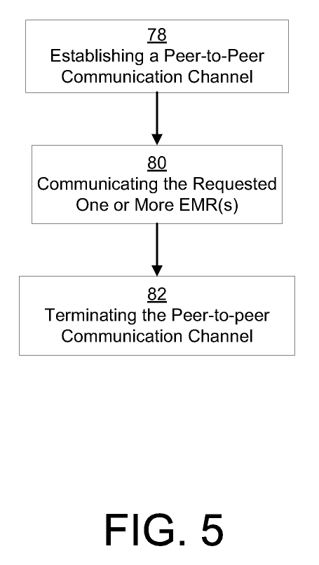

If the requested EMR is available, the client computer system 14b generates a positive query response (step 74) and communicates the positive query response to the proxy computer system 12 (step 76). The proxy computer system 12 then facilitates a peer-to-peer EMR transfer as described with reference to FIG. 5.

In an alternate embodiment, the proxy query is communicated over the communication network 17 without regard to the region of the client computer systems 14 receiving the proxy query. In such a case, the processor 24c includes the proxy query region information in the proxy query. Upon receiving the proxy query, each individual client computer system 14 determines whether it is located within the region specified in the proxy query. If it is not in the specified region, it does not perform a search or respond to the proxy query. If it is within the specified region, it performs a search as described with reference to FIG. 5.

In an alternate embodiment, once the medical records network 10 is accessed (step 52) by a client computer system 14, the client computer system 14 periodically communicates, for example every 30 or 60 seconds, a heartbeat data packet indicating the client computer system 14 remains connected to the medical records network 10. The heartbeat data packet is typically protected by implementing standards-based, best-of-class encryption algorithms selected from AES, DES, triple-DES, RC4, MACs, SSL, TLS, RSA, DSA or algorithms having similar security capabilities. Each heartbeat data packet includes identification information indicating the network and/or geographic location of the client computer system 14. The proxy computer system 12 receives each heartbeat data packet and compares its identification information with the query region information of any received record request query. If the heartbeat identification information matches the query region information, the proxy query is communicated to the client computer system 14 that communicated the heartbeat data packet (step 62). In some embodiments, the record request query remains active, that is, available for comparison to the heartbeat identification information from heartbeat data packets until a positive query response is generated (step 74).

With reference to FIG. 5, the process steps for communicating one or more EMR(s) between two client computer systems 14 is shown. Upon receipt of a positive query response, the proxy computer system 12 establishes a communication channel (step 78) via the communication network 17 between the client computer system 14a that generated the record request (step 56) and the client computer system 14b that generated the positive query response (step 74). This communication channel is also referred to as a “peer-to-peer” connection because, once the communication channel has been established, the data does not pass through the proxy computer system 12. Rather, the data moves over the communication network directly between the two client computer systems 14a and 14b. Once the communication channel is established, the client computer systems 14a and 14b negotiate a data transfer mechanism in order to transfer the requested EMR(s). The data transfer mechanism is negotiated as a HL7, ADT feed, DICOM, HTML, XML, FTP or any other similar data transfer mechanism. In applications where a DICOM, HL7 or similar data transfer mechanism is used, explicit client computer system 14 identification is required. Such identification is facilitated by the proxy computer system 12 allowing a peer-to-peer transfer in the preferred embodiment, and in other embodiments, the EMR is transferred through the proxy computer system 12. The client computer system 14b communicates the requested one or more EMR(s) over the communication channel to the client computer system 14a (step 80). Finally, the communication channel is terminated upon completion of the communication of the one or more requested EMR(s) (step 82).

In the preferred embodiment, similar to step 42 (FIG. 3), the integrity of the communication of step 80 is protected by implementing standards-based, best-of-class encryption algorithms selected from AES, DES, triple-DES, RC4, MACs, SSL, TLS, RSA, DSA or algorithms having similar security capabilities.

In alternate embodiments, each record request must include an authentication request. Before the record request is processed by the proxy computer system 12 and the proxy query is communicated over the communication network, the authentication is processed. The authentication process described with reference to FIG. 3 is included in the process for requesting a record request as discussed with reference to FIG. 4. For example, the authentication request is generated as part of the record request query (step 56), and the record request query including the authentication request is communicated to the proxy computer system (step 58). Then steps 44, 46, 48, 50, and 52 are preformed as described above to complete the query request process.

In the preferred embodiment, a system use log is stored in the proxy database 31. The system use log includes information corresponding to authentication requests, record request queries, EMR communications, and any other network events. The system use log allows monitoring of the medical records network including identification of abuses or violations. In some embodiments, a client computer log is stored in the local EMR database 25a or other memory of the client computer system 14a. The client computer log includes information corresponding to the record request queries generated by the client computer system 14a, the proxy queries received by the client computer system 14a, the positive query responses generated by the client computer system 14a, the negative query responses generated by the client computer system 14a, the peer-to-peer communication channels involving the client computer system 14a and other events involving the client computer system 14a.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A medical records network for providing communication between a plurality of client computer systems, one or more of which store medical records, the medical records network comprising:
a first client computer system comprising:
a first client processor for executing instructions to provide access to medical records;
a first agent application running on the first client processor, the first agent application for generating an authentication request and for generating a first record request query to request access to one or more medical records stored on one or more other client computer systems, the first record request query including query information for identifying the one or more medical records to be accessed;
a communication network connected to the first client computer system, the communication network for communicating the authentication request and the first record request query to one or more other computer systems connected to the communication network;
a proxy computer system connected to the communication network and operable to receive the authentication request and the first record request query, the proxy computer system comprising:
a proxy database containing at least authentication data;
a proxy processor for executing instructions to access the authentication data contained in the proxy database and determine whether one or more of the client computer systems are authorized to communicate over the medical records network, the proxy processor also for executing instructions to enable communications between client computer systems authorized to communicate medical records over the medical records network;
a proxy application running on the proxy processor, the proxy application for determining, based at least in part on the accessed authentication data and the authentication request, whether the first client computer system is authorized to communicate over the medical records network, the proxy application further for generating a first proxy query based on the query information in the first record request query;
the communication network for communicating the first proxy query to one or more other computer systems connected to the communication network;
a second client computer system connected to the communication network and operable to receive the first proxy query, the second client computer system comprising:
a second client processor for executing instructions to provide access to medical records;
a second client database containing one or more medical records;
a second agent application running on the second client processor, the second agent application for determining, based on the first proxy query, whether the one or more medical records requested by the first client computer system are contained in the second client database, the second agent application for generating a positive query response when the one or more medical records requested by the first client computer system are contained in the second client database;
the communication network for communicating the positive query response to the proxy computer system; and
the proxy application for receiving the positive query response and establishing a secure communication channel via the communication network between the first client computer system and the second client computer system based on the positive query response, whereby the second client computer system may communicate the requested one or more medical records to the first client computer system via the secure communication channel.

2. The medical records network of claim 1 wherein the first record request query includes the authentication request.

3. The medical records network of claim 1 wherein the first record request query includes identification information for identifying the first client computer system.

4. The medical records network of claim 1 wherein the authentication request includes a first password and the authentication data contains at least a second password.

5. The medical records network of claim 4 wherein the proxy processor determines whether the first password corresponds to the second password and therefore whether the first client computer system is authorized to communicate over the medical records network based at least in part on whether the first password corresponds to the second password.

6. The medical records network of claim 1 wherein the authentication data comprises access information representing one or more client computer systems authorized to access the medical records network.

7. The medical records network of claim 6 wherein the authentication request includes identification information for identifying the first client computer system.

8. The medical records network of claim 7 wherein the proxy processor determines whether the identification information corresponds to at least one of the client computer systems represented by the access information and therefore whether the first client computer system is authorized to communicate over the medical records network.

9. A method for providing communication over a medical records network comprising a plurality of client computer systems, where one or more of the client computer systems is operable for storing medical records, the method comprising:
(a) generating an authentication request and a first record request query at a first client computer system, the first record request query for requesting access to one or more medical records stored on one or more client computer systems other than the first client computer system, the first record request query including query information for identifying the one or more medical records to be accessed;
(b) communicating the authentication request and the first record request query to one or more computer systems other than the first client computer system connected to a communication network;
(c) receiving the authentication request and the first record request query at a proxy computer system connected to the communication network;
(d) accessing authentication data contained in a proxy database of the proxy computer system;
(e) determining that the first client computer system is authorized to communicate over the medical records network based at least in part on the accessed authentication data and the authentication request;
(f) generating a first proxy query at the proxy computer system based on the query information in the first record request query;
(g) communicating the first proxy query from the proxy computer system to one or more other computer systems connected to the communication network;
(h) receiving the first proxy query at a second client computer system connected to the communication network;
(i) accessing a second client database that is associated with the second client computer system;
(j) determining, based on the first proxy query, whether the one or more medical records requested by the first client computer system are contained in the second client database;
(k) generating a positive query response when the one or more medical records requested by the first client computer system are contained in the second client database;
(l) communicating the positive query response to the proxy computer system;
(m) receiving the positive query response at the proxy computer system; and
(n) establishing a communication channel via the communication network between the first client computer system and the second client computer system based on the positive query response, whereby the second client computer system may communicate the requested one or more medical records to the first client computer system via the communication channel.

10. The method of claim 9 wherein the first record request query includes the authentication request.

11. The method of claim 9 wherein the first record request query includes the identification information for identifying the first client computer system.

12. The method of claim 9 wherein the authentication request includes a first password and the authentication data contains at least a second password.

13. The method of claim 12 further comprising determining that the first password corresponds to the second password and therefore that the first client computer system is authorized to communicate over the medical records network.

14. The method of claim 9 wherein the authentication data includes access information representing one or more client computer systems authorized to access the medical records network.

15. The method of claim 14 wherein the authentication request includes identification information for identifying the first client computer system.

16. The method of claim 15 wherein the proxy processor determines whether the identification information corresponds to at least one of the client computer systems represented by the access information and therefore whether the first client computer system is authorized to communicate over the medical records network.

17. The method of claim 9 further comprising:
(o) generating a negative query response when the one or more medical records requested by the first client computer system are not found in the second client database;
(p) communicating the negative query response to the proxy computer system;
(q) receiving the negative query response at the proxy computer system; and
(r) generating a second record request query which is at least in part distinct from the first record request query.

18. The method of claim 9 wherein the authentication request includes client information and the method further comprises storing the client information at the proxy computer system.

19. The method of claim 18 wherein the client information includes region information indicating a geographic location of the first client computer system and network identification information indicating a unique network address of the first client computer system.

20. The method of claim 9 further comprising storing client region information in the proxy database, where the client region information indicates geographic locations of one or more client computer systems authorized to access medical records via the medical records network, and wherein the first record request query includes query region information indicating a geographic region within which to communicate the first proxy query and the method further comprises determining which, if any, of the client region information stored in the proxy database corresponds with the query region information, and wherein step (g) comprises communicating the first proxy query to the one or more client computer systems in geographic locations corresponding with the query region information in the first record request query.

21. A medical records network for providing communication between a plurality of client computer systems, one or more of which store medical records, the medical records network comprising:
(a) means for generating an authentication request and a first record request query at a first client computer system, the first record request for requesting access to one or more medical records stored on one or more client computer systems other than the first client computer system, the first record request query including query information for identifying the one or more medical records to be accessed;
(b) means for communicating the authentication request and the first record request query to one or more computer systems other than the first client computer system connected to a communication network;
(c) means for receiving the authentication request and the first record request query at a proxy computer system connected to the communication network;
(d) means for accessing authentication data contained in a proxy database of the proxy computer system;
(e) means for determining that the first client computer system is authorized to communicate over the medical records network based at least in part on the accessed authentication data and the authentication request;
(f) means for generating a first proxy query at the proxy computer system based on the query information in the first record request query;
(g) means for communicating the first proxy query from the proxy computer system to one or more other computer systems connected to the communication network;
(h) means for receiving the first proxy query at a second client computer system connected to the communication network;
(i) means for accessing a second client database that is associated with the second client computer system;
(j) means for determining, based on the first proxy query, whether the one or more medical records requested by the first client computer system are contained in the second client database;
(k) means for generating a positive query response when the one or more medical records requested by the first client computer system are contained in the second client database;
(l) means for communicating the positive query response to the proxy computer system;
(m) means for receiving the positive query response at the proxy computer system; and
(n) means for establishing a communication channel via the communication network between the first client computer system and the second client computer system based on the positive query response, whereby the second client computer system may communicate the requested one or more medical records to the first client computer system via the communication channel.
